(19) United States
(12) Patent Application Publication
(10) Pub. No.: US 2010/0314075 A1
(43) Pub. Date: Dec. 16, 2010

(54) COOLING PLATE AND MANUFACTURING METHOD THEREFOR

(76) Inventors: Satoshi TAKAHASHI, Mihara (JP); Seiji Matsushima, Mihara (JP)

Correspondence Address: WENDEROTH, LIND & PONACK, L.L.P., 1030 15th Street, N.W.,, Suite 400 East, Washington, DC, 20005-1503, US

(21) Appl. No.: 12/603,776

(22) Filed: Oct. 22, 2009

(30) Foreign Application Priority Data
Jun. 12, 2009 (JP) 2009-141013

(51) Int. Cl. F28D 15/00; B23P 15/26

(52) U.S. Cl. 165/104.19; 29/890.035

(57) ABSTRACT

A cooling plate configured so that the cooling efficiency can be improved, the weight can be reduced, high corrosion resistance can be provided, the work efficiency can be improved, and furthermore the manufacturing cost can be reduced, and a manufacturing method for the cooling plate is provided. The manufacturing method for a cooling plate including a cooling plate body 2, a groove 3 formed so as to open to a top surface 2a of the cooling plate body 2, a lid member 4 that is arranged so as to close the opening of the groove 3, and is joined to the cooling plate body 2 by friction stir welding, and a refrigerant passage 1 having a transverse cross section defined by the groove 3 and the whole of a back surface 4c of the lid member 4, comprises the steps of: fitting the lid member 4 to the groove 3 and then temporarily tacking the lid member 4 to cooling plate body 2; and placing a rotation center 6a of a friction stir welding tool at a position which separates from the fitting position between the lid member 4 and the groove 3 to the outside through a distance d in the width direction after temporary tacking, and then performing friction stir welding. The cooling plate is manufactured by the above-described manufacturing method for a cooling plate.

### FIELD OF THE INVENTION

The present invention relates to a cooling plate manufactured by joining a lid member for closing a groove which is provided in a cooling plate body, to the cooling plate body by friction stir welding, and a manufacturing method for the cooling plate.

### BACKGROUND OF THE INVENTION

In a manufacturing process for industrial products, a cooling plate for cooling a heat generating object is sometimes used. In a sputtering system used to manufacture semiconductors, flat panel displays, and the like, a cooling plate called “a backing plate” has been used to dissipate the heat generated on a target material during sputtering.

Such a cooling plate is provided with a refrigerant passage for causing a refrigerant to flow therein. Japanese Unexamined Patent Application Publication No. 2002-248584 discloses a cooling plate having a refrigerant passage and a manufacturing method therefor. This cooling plate is provided with a groove that is open to the top surface of a cooling plate body made of copper, aluminum, or the like material, and a lid member is provided so as to close the opening of the groove. In the transverse cross section of the cooling plate body, a step part is formed on both walls of the groove in the width direction, so that the lower part on the bottom side has a narrow width and the upper part on the surface side has a wide width. The lid member is configured so as to be received by the upper surfaces of the step parts between both the walls in the wide-width part in the groove. Therefore, in the state in which the lid member is received by the upper surfaces of the wide-width part of the groove, both the walls of the groove in the cooling plate body and both ends in the width direction of the lid member are joined to each other by friction stir welding. Thereby, the refrigerant passage is formed by being surrounded by a part of the back surface of the lid member and the groove of the cooling plate body. Furthermore, at the time of friction stir welding, it is necessary to firmly press the cooling plate body and the lid member arranged on the step parts of the groove. For this purpose, temporary tacking is performed by spot welding, punch fixing, or the like means.

### BRIEF SUMMARY OF THE INVENTION

Unfortunately, for the cooling plate described in Japanese Unexamined Patent Application Publication No. 2002-248584, the temporary tacking which is performed by spot welding, punch fixing, or the like means, has problems in that the manufacturing process for the cooling plate is made complex, the work efficiency is lowered, and the manufacturing cost is increased.

The refrigerant flows in the narrow-width part of the transverse cross section of the groove, and both the end parts in the width direction of the lid member are joined to the wide-width part of the groove. Therefore, the internal pressure which is applied from the refrigerant to a part of the back surface of the lid member, is determined by the width of the narrow-width part of the groove. That is to say, in the groove, the width of the narrow-width part that determines the internal pressure, and the width of the wide-width part in which both the end parts of the lid member, are joined are different from each other. Therefore, the calculation for setting the entire width of the lid member so as to withstand the internal pressure, is made intricate, which results in intricate design of cooling plate. Furthermore, if the narrow-width part in which the refrigerant flows is increased to improve the cooling efficiency, the width of the wide-width part in which both the end parts of the lid member are joined is also increased, so that not only the refrigerant passage in the groove but also the structure such as the step part for supporting the lid member is made large. Therefore, the ratio of area occupied by the refrigerant passage in the cooling plate in a fixed area becomes low, which poses a problem in reducing the total weight of the cooling plate. Furthermore, the contact part between a part of the back surface of the lid member and the upper surface of the step part of the groove is not bonded, so that a gap is formed therein. In the case in which the refrigerant enters this gap, corrosion may occur. In addition, in the case in which foreign matters deposit in the gap, due to the deposits, the cooling effect of refrigerant becomes difficult to be conveyed to the surface of the cooling plate, which deteriorates the heat exchange performance of the cooling plate.

The present invention has been made in view of the above circumstances, and accordingly an object thereof is to provide a cooling plate configured so that the cooling efficiency can be improved, the total weight can be reduced, high corrosion resistance can be provided, the work efficiency can be improved, and furthermore the manufacturing cost can be reduced, and a manufacturing method for the cooling plate.

To achieve the above object, the present invention provides a manufacturing method for a cooling plate including a cooling plate body, a groove formed so as to open to a top surface of the cooling plate body, a lid member which is arranged so as to close the opening of the groove, and is joined to the cooling plate body by friction stir welding, and a refrigerant passage having a transverse cross section defined by the groove and the whole of a back surface of the lid member, the method including the steps of: fitting the lid member to the groove, and then temporarily tacking the lid member to cooling plate body; and placing a rotation center of a friction stir welding tool at a position on the outside of the fitting position between the lid member and the groove in the width direction after temporary tacking, and then performing friction stir welding.

In the manufacturing method for a cooling plate in accordance with the present invention, in the state before temporary tacking, the width of the transverse cross section in the fitting part of the lid member is wider than the width of the transverse cross section in the fitting part of the groove, and in the state after temporary tacking, the lid member is fitted in the groove by interference fit.

In the manufacturing method for a cooling plate in accordance with the present invention, the end part of the fitting part of the lid member in the width direction is formed into a tapered shape.

In the manufacturing method for a cooling plate in accordance with the present invention, the rotation center of the tool is placed at a position on the outside of the fitting position between the lid member and the groove in the width direction, so that the lid member is joined to the cooling plate body throughout the whole in the thickness direction of the lid member at the fitting position.

In the manufacturing method for a cooling plate in accordance with the present invention, the rotation center of the tool is placed at a position on the outside of the fitting position between the lid member and the groove in the width direction, so that the tool does not bite into the groove when friction stir welding is performed.

In the manufacturing method for a cooling plate in accordance with the present invention, a collar part is provided in both the end parts of the lid member in the width direction.

The cooling plate in accordance with the present invention is manufactured by the above-described manufacturing method for a cooling plate.

According to the present invention, the manufacturing method for a cooling plate including the cooling plate body, the groove formed so as to open to the top surface of the cooling plate body, the lid member that is arranged so as to close the opening of the groove, and is joined to the cooling plate body by friction stir welding, and a refrigerant passage having the transverse cross section defined by the groove and the whole of the back surface of the lid member, comprises the steps of: fitting the lid member to the groove, and then temporarily tacking the lid member to cooling plate body; and placing the rotation center of the friction stir welding tool at a position on the outside in the width direction of the fitting position between the lid member and the groove after temporary tacking, and then performing friction stir welding.

Therefore, temporary tacking can be performed by only the fitting between the lid member and the groove, and spot welding, punch fixing, or the like means need not be accomplished to perform temporary tacking, so that the manufacturing efficiency is improved, and the manufacturing cost is reduced.

In the transverse cross section of the refrigerant passage, the internal pressure from the refrigerant is applied to the whole of the back surface of the lid member, and the width of a region in which the lid member receives the internal pressure from the refrigerant, is equal to the joint width that is arranged between the joint parts between the lid member and the cooling plate body. Therefore, a cooling plate capable of withstanding the internal pressure of refrigerant can be designed easily.

Furthermore, the groove does not include a structure such as a step part for supporting the lid member, and only a cavity constituting the refrigerant passage is formed in the groove. Therefore, in the case in which the cooling efficiency of the cooling plate is to be improved, the peripheral structure for supporting the lid member does not expand in the width direction while increasing the width which constitutes the refrigerant passage of the groove, so that the total weight of the cooling plate is reduced easily.

In the transverse cross section around the refrigerant passage, the contact part between the cooling plate body and the lid member is only a portion of bonding performed by friction stir welding, so that a gap is not formed. Therefore, there is no possibility of corrosion caused by refrigerant entered into the gap, and also there is no possibility of deteriorated heat exchange performance of the cooling plate caused by the foreign matters deposited in the gap.

In the manufacturing method for a cooling plate in accordance with the present invention, in the state before temporary tacking, the width of the transverse cross section in the fitting part of the lid member is wider than the width of the transverse cross section in the fitting part of the groove, and in the state after temporary tacking, the lid member is fitted in the groove by interference fit. Therefore, in the temporarily tacked state, the lid member is fitted in the groove by interference fit surely, so that in the state in which the lid member is firmly held in the groove, friction stir welding can be performed reliably, and therefore the manufacturing efficiency is improved.

In the manufacturing method for a cooling plate in accordance with the present invention, the end part of the fitting part of the lid member in the width direction is formed into a tapered shape. Therefore, when the lid member is fitted to the groove, the lid member is easily guided into the groove. Thereby, the tacking work is performed easily, and therefore the manufacturing efficiency can be improved.

In the manufacturing method for a cooling plate in accordance with the present invention, the rotation center of the tool is placed at a position on the outside of the fitting position between the lid member and the groove in the width direction, so that the lid member is joined to the cooling plate body throughout the whole in the thickness direction of the lid member at the fitting position. Therefore, the lid member can be joined to the cooling plate body reliably and firmly, and the manufacturing efficiency can be improved.

In the manufacturing method for a cooling plate in accordance with the present invention, the rotation center of the tool is placed at a position on the outside of the fitting position between the lid member and the groove in the width direction, so that the tool does not bite into the groove when friction stir welding is performed. Therefore, at the time of friction stir welding, the lid member is not pressed directly by the tip end part of the tool, so that the lid member in a temporarily tacked state can be prevented from shifting. Furthermore, the tip end part of the tool is reliably prevented from biting into the refrigerant passage, so that the refrigerant passage is less liable to be distorted. For example, even in the case in which the tip end part of the tool entering an object to be worked is made longer than the thickness of the lid member to reliably join the lid member to the cooling plate body, the tip end part of the tool can be prevented from biting into the refrigerant passage. Therefore, the lid member can be reliably joined to the cooling plate body, so that the manufacturing efficiency can be improved.

In the manufacturing method for a cooling plate in accordance with the present invention, the collar part is provided in both the end parts in the width direction of the lid member. Therefore, in addition to the advantageous effects described above, at the temporary tacking time, in the state in which the collar part of the lid member is reliably supported from the thickness direction by the cooling plate body, and the lid member is firmly held in the groove, friction stir welding can be performed more reliably, so that the manufacturing efficiency can be improved.

The cooling plate in accordance with the present invention is manufactured by the above-described manufacturing method for a cooling plate. Therefore, high corrosion resistance can be provided, the deterioration in heat exchange performance can be prevented, the work efficiency can be improved, and furthermore, the manufacturing cost can be reduced.

### BRIEF DESCRIPTION OF THE DRAWINGS

FIG. 1 is a transverse sectional view showing a transverse cross section of a cooling plate in accordance with a first embodiment of the present invention;

FIG. 2 is an enlarged transverse sectional view showing the surroundings of a solid phase bonding part during the work of friction stir welding in accordance with a first embodiment of the present invention;

FIG. 3 is a transverse sectional view showing a transverse cross section of a cooling plate in accordance with a second embodiment of the present invention; and

FIG. 4 is an enlarged transverse sectional view showing the surroundings of a solid phase bonding part during the work of friction stir welding in accordance with a second embodiment of the present invention.

### DETAILED DESCRIPTION OF THE INVENTION

### First Embodiment

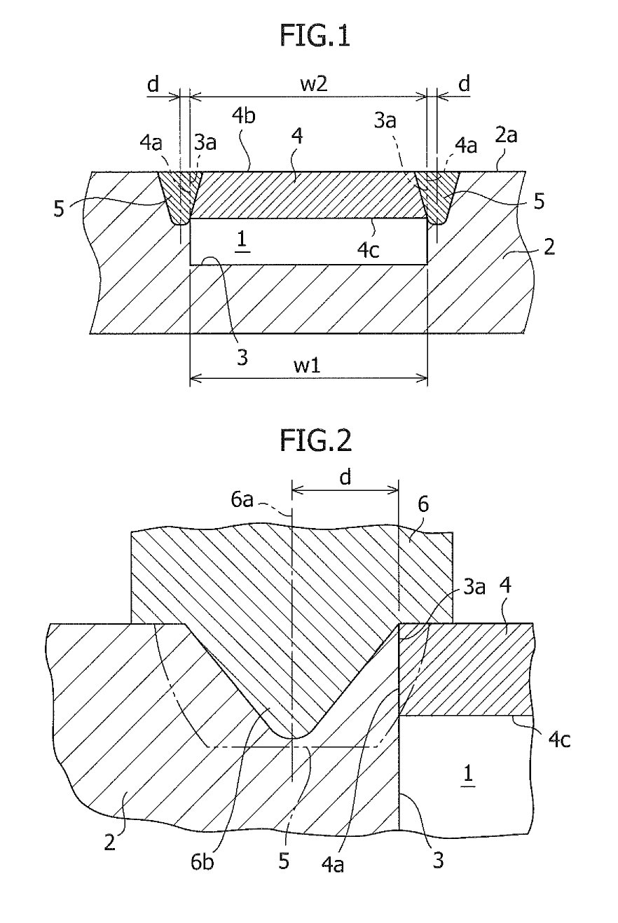

A cooling plate and a manufacturing method for the cooling plate in accordance with a first embodiment of the present invention will now be described with reference to the accompanying drawings. FIG. 1 is a transverse sectional view showing the surroundings of a refrigerant passage 1 of the cooling plate in accordance with the first embodiment. Referring to FIG. 1, the feature of the transverse cross section of the cooling plate is explained. The cooling plate has a cooling plate body 2. The cooling plate body 2 is provided with a groove 3 formed into a concavity shape so as to open to a top surface 2a thereof. A lid member 4 is disposed so as to close the opening of the groove 3, and both end parts 4a of the lid member 4 in the width direction come into contact with fitting parts 3a of the groove 3. A top surface 4b of the lid member 4 is formed so as to be flush with the top surface 2a of the cooling plate body 2. The refrigerant passage 1 is defined by the bottom surface of the groove 3, the wall parts of the groove 3, and a back surface 4c of the lid member 4.

In the state in which the lid member 4 fits in the groove 3, the relationship of w1=w2 holds, in which w1 is a width between the pair of fitting parts 3a in the transverse cross section of the groove 3, and w2 is a width of the transverse cross section of the lid member 4. On the other hand, although not shown in the figure, in the state in which the lid member 4 is removed from the groove 3, the width of the transverse cross section of the lid member 4 is set so as to be wider than the width between the pair of fitting parts 3a in the transverse cross section of the groove 3. That is to say, in the state before temporary tacking, the lid member 4 has a width wider than the width between the fitting parts 3a in the transverse cross section of the groove 3, and on the other hand, in the state after temporary tacking, the lid member 4 is fitted in the fitting parts 3a of the groove 3 by interference fit.

The groove 3 and the lid member 4 are joined to each other by solid phase bonding parts 5 which are formed by the execution of friction stir welding. The center of the solid phase bonding part 5 is located at a position separate in the width direction from the fitting position between the groove 3 and the lid member 4 to the outside through a distance d.

Referring to FIG. 2, the feature of the transverse cross section around the solid phase bonding part 5 during the friction stir welding in accordance with the first embodiment, is explained. In friction stir welding, a tool 6 is used. The tool 6 is configured so as to be rotatable around a rotation axis 6a. The rotation axis 6a is located at a position which separates from the fitting position between the groove 3 and the lid member 4 to the outside through the distance d in the width direction. A tip end part 6a of the tool 6 enters the cooling plate body 2. When friction stir welding is performed, the solid phase bonding part 5 is formed as indicated by an imaginary line.

The solid phase bonding part 5 is formed into a substantially trapezoidal shape so as to bond the whole in the thickness direction of the lid member 4. The solid phase bonding part 5 may enter the refrigerant passage 1 as far as the whole in the thickness direction of the lid member 4 is bonded. Regarding the optimum conditions for the distance d between the rotation axis 6a of the tool 6, and the fitting position between the groove 3 and the lid member 4, the lid member 4 should be prevented from sinking from the fitting position to the bottom side of the groove 3 when the tool 6 is pressed against the cooling plate to perform friction stir welding, the lid member 4 should be bonded as a whole in the thickness direction, unnecessary metal run should not be produced, and the tip end part 6b of the tool 6 should be prevented from biting into the refrigerant passage 1 and the lid member 4. As one example of a method for determining such a value of distance d, an optimum value of the distance d such as to meet the above-described optimum conditions, should be determined by performing friction stir welding while changing the value of distance d and by verifying the shape of transverse cross section of the formed solid phase bonding part 5.

Next, a manufacturing method for the cooling plate in accordance with the first embodiment of the present invention is explained.

The lid member 4 is fitted to the fitting parts 3a of the groove 3 in the cooling plate body 2, and the lid member 4 is temporarily tacked to the cooling plate body 2. After temporary tacking, the rotation axis 6a of the friction stir welding tool 6 is placed at a position which separate from the fitting position between the groove 3 and the lid member 4 to the outside through the distance d in the width direction. The tool 6 is rotated around the rotation axis 6a to perform friction stir welding.

As described above, according to the first embodiment of the present invention, temporary tacking can be performed merely by fitting the lid member 4 to the groove 3. Therefore, spot welding, punch fixing, or the like means need not be accomplished to perform temporary tacking, so that the manufacturing efficiency can be improved, and the manufacturing cost can be reduced.

In the transverse cross section of the refrigerant passage 1, the internal pressure from the refrigerant is applied to the whole of the back surface 4c of the lid member 4, and the width of a region in which the lid member 4 receives the internal pressure from the refrigerant, is equal to the joint width between the joint parts between the lid member 4 and the cooling plate body 2. Therefore, a cooling plate capable of withstanding the internal pressure of refrigerant can be designed easily.

Furthermore, the groove 3 is not formed with a structure such as a step part for supporting the lid member 4, and only a cavity constituting the refrigerant passage 1 is formed. Therefore, in the case in which the cooling efficiency of the cooling plate is to be improved, the peripheral structure for supporting the lid member 4 does not expand in the width direction while increasing the width which constitutes the refrigerant passage 1 in the groove 3, so that the total weight of the cooling plate can be reduced easily.

In the transverse cross section around the refrigerant passage 1, the contact part between the cooling plate body 2 and the lid member 4 is only a portion of bonding performed by friction stir welding, so that a gap is not formed. Therefore, there is no possibility of corrosion caused by entering refrigerant into the gap, and also there is no possibility of deteriorated heat exchange performance of the cooling plate caused by the foreign matters deposited in the gap.

According to the first embodiment of the present invention, in the temporarily tacked state, the lid member 4 is fitted in the groove 3 by interference fit surely. Therefore, in the state in which the lid member 4 is firmly held in the groove 3, friction stir welding can be performed reliably, and therefore the manufacturing efficiency can be improved.

According to the first embodiment of the present invention, the lid member 4 is joined to the cooling plate body 2 throughout the whole in the thickness direction thereof. Therefore, the lid member 4 can be joined to the cooling plate body 2 reliably and firmly, so that the manufacturing efficiency can be improved.

According to the first embodiment of the present invention, at the time of friction stir welding, the lid member 4 is not pressed directly by the tip end part 6a of the tool 6, so that the lid member 4 in a temporarily tacked state can be prevented from shifting. Furthermore, the tip end part 6a of the tool 6 is reliably prevented from biting into the refrigerant passage 1, so that the refrigerant passage 1 is less liable to become distorted. For example, even in the case in which the tip end part 6a of the tool 6 entering an object to be worked is made longer than the thickness of the lid member 4 to reliably join the lid member 4 to the cooling plate body 2, the tip end part 6a of the tool 6 can be prevented from biting into the refrigerant passage 1. Therefore, the lid member 4 can be reliably joined to the cooling plate body 2, so that the manufacturing efficiency can be improved.

In the first embodiment of the present invention, since the cooling plate is manufactured by the above-described manufacturing method for the cooling plate, a cooling plate configured so that high corrosion resistance can be provided, the deterioration in heat exchange performance can be prevented, the work efficiency can be improved, and furthermore the manufacturing cost can be reduced can be provided.

### Second Embodiment

A cooling plate and a manufacturing method for the cooling plate in accordance with a second embodiment of the present invention will now be described with reference to the accompanying drawings. The basic feature of the cooling plate and the manufacturing method for the cooling plate in accordance with the second embodiment is the same as the feature in the first embodiment. Elements that are the same as those in the first embodiment are explained by using the symbols and names that are the same as those in the first embodiment. Hereunder, a feature that is different from that of the first embodiment is explained.

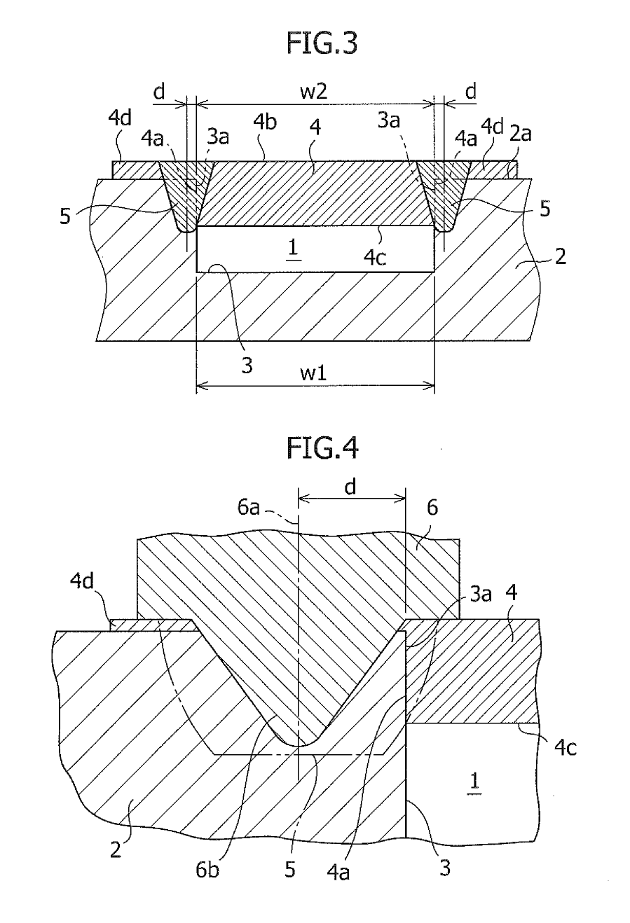

FIG. 3 is a transverse sectional view showing the surroundings of the refrigerant passage 1 of the cooling plate in accordance with the second embodiment. Referring to FIG. 3, the feature of the transverse cross section of the cooling plate is explained. In both the end parts 4a of the lid member 4 in the width direction, a collar part 4d is provided.

Referring to FIG. 4, the feature of the transverse cross section of the surroundings of the solid phase bonding part 5 during the work of friction stir welding in the second embodiment is explained. The collar part 4d is formed along the top surface 2a of the cooling plate body 2. The solid phase bonding part 5 is formed so as to penetrate the collar part 4d of the lid member 4 and so as to bond the groove 3 and the lid member 4.

The manufacturing method for the cooling plate in accordance with the second embodiment of the present invention is also the same as that in the first embodiment.

As described above, according to the second embodiment of the present invention, in addition to the advantageous effects of the first embodiment, at the temporary tacking time, in the state in which the collar part 4d of the lid member 4 is reliably supported from the thickness direction by the cooling plate body 2, and the lid member 4 is firmly held in the groove 3, friction stir welding can be performed more reliably, so that the manufacturing efficiency can be improved.

In this specification, the embodiments of the present invention have been described. The present invention is not limited to these embodiments, and various modifications and changes can be made based on the technical concept of the present invention.

For example, as a first modification of the embodiments of the present invention, in the first and second embodiments, the end part 4a of the lid member 4 in the width direction may be formed into a tapered shape. In this case, when the lid member 4 is fitted to the groove 3, the lid member 4 is easily guided into the groove 3. Therefore, the tacking work is performed easily, and therefore the manufacturing efficiency can be improved.

As a second modification of the embodiments of the present invention, in the first and second embodiments, the part on the bottom side from the fitting parts 3a of the groove 3 may be narrower in the width direction toward the bottom side of the groove 3, or may be wider in the width direction toward the bottom side of the groove 3. In this case, the same advantageous effect as that of the first and second embodiments can be achieved.

1. A manufacturing method for a cooling plate including a cooling plate body, a groove formed so as to open to a top surface of the cooling plate body, a lid member which is arranged so as to close the opening of the groove, and is joined to the cooling plate body by friction stir welding, and a refrigerant passage having a transverse cross section defined by the groove and the whole of a back surface of the lid member, the method comprising the steps of:
fitting the lid member to the groove, and then temporarily tacking the lid member to cooling plate body; and
placing a rotation center of a friction stir welding tool at a position on the outside of the fitting position between the lid member and the groove in the width direction after temporary tacking, and then performing friction stir welding.

2. The manufacturing method for a cooling plate according to claim 1, wherein in the state before temporary tacking, the width of the transverse cross section in the fitting part of the lid member is wider than the width of the transverse cross section in the fitting part of the groove, and in the state after temporary tacking, the lid member is fitted in the groove by interference fit.

3. The manufacturing method for a cooling plate according to claim 2, wherein the end part of the fitting part of the lid member in the width direction is formed into a tapered shape.

4. The manufacturing method for a cooling plate according to claim 1, wherein the rotation center of the tool is placed at a position on the outside of the fitting position between the lid member and the groove in the width direction, so that the lid member is joined to the cooling plate body throughout the whole in the thickness direction of the lid member at the fitting position.

5. The manufacturing method for a cooling plate according to claim 1, wherein the rotation center of the tool is placed at a position on the outside of the fitting position between the lid member and the groove in the width direction, so that the tool does not bite into the groove when friction stir welding is performed.

6. The manufacturing method for a cooling plate according to claim 1, wherein a collar part is provided in both the end parts of the lid member in the width direction.

7. A cooling plate manufactured by the manufacturing method for a cooling plate described in claim 1.

8. The manufacturing method for a cooling plate according to claim 2, wherein the rotation center of the tool is placed at a position on the outside of the fitting position between the lid member and the groove in the width direction, so that the lid member is joined to the cooling plate body throughout the whole in the thickness direction of the lid member at the fitting position.

9. The manufacturing method for a cooling plate according to claim 3, wherein the rotation center of the tool is placed at a position on the outside of the fitting position between the lid member and the groove in the width direction, so that the lid member is joined to the cooling plate body throughout the whole in the thickness direction of the lid member at the fitting position.

10. The manufacturing method for a cooling plate according to claim 2, wherein the rotation center of the tool is placed at a position on the outside of the fitting position between the lid member and the groove in the width direction, so that the tool does not bite into the groove when friction stir welding is performed.

11. The manufacturing method for a cooling plate according to claim 3, wherein the rotation center of the tool is placed at a position on the outside of the fitting position between the lid member and the groove in the width direction, so that the tool does not bite into the groove when friction stir welding is performed.

12. The manufacturing method for a cooling plate according to claim 2, wherein a collar part is provided in both the end parts of the lid member in the width direction.

13. The manufacturing method for a cooling plate according to claim 3, wherein a collar part is provided in both the end parts of the lid member in the width direction.

14. A cooling plate manufactured by the manufacturing method for a cooling plate described in claim 2.

15. A cooling plate manufactured by the manufacturing method for a cooling plate described in claim 3.
